(19) United States
(12) Patent Application Publication
(10) Pub. No.: US 2011/0161644 A1
(43) Pub. Date: Jun. 30, 2011

(54) INFORMATION PROCESSOR

(76) Inventors: Tohru Nojiri, Tokyo (JP); Keisuke Toyama, Yokohama (JP); Yoshiko Nagasaka, Kokubunji (JP); Yuji Saeki, Tokyo (JP)

(21) Appl. No.: 12/676,600

(22) PCT Filed: Feb. 26, 2009
(86) PCT No.: PCT/JP2009/053546

§ 371 Date: Jul. 9, 2010

(51) Int. Cl. G06F 9/06

(52) U.S. Cl. 713/1

(57) ABSTRACT

When a plurality of OSs are mounted, it is desirable to efficiently use memory resources without affecting other OSs. Also, even if the OSs are different from each other, they are mounted on one system, and therefore, inter-OS communication is required. In this case, data communication without affecting other OSs is required. Accordingly, an information processor includes: a firmware for assigning a first central processing unit, a first operating system, and a first region being a partial region of a memory as a first domain, assigning a second central processing unit, a second operating system, and a second region being a partial region of the memory as a second domain, and controlling to disable an access of one domain to a region assigned for the other domain; and a middleware for controlling a communication when the data communication is required between the first domain and the second domain. Further, when a sharable code is available in the operating systems, the code is stored in a region of the memory to which only a read access of each domain is enabled. Still further, when the communication is executed between the domains, with a state that the access to the memory region for the communication is limited by the middleware and the firmware, each domain accesses the region.

### TECHNICAL FIELD

The present invention relates to a data processor in which a plurality of central processing units and an on-chip memory are included or whose program is executable under controls of different operating systems, and the present invention relates to a technique effectively applied to, for example, a micro processor of a semiconductor integrated circuit including a multi CPU (central processing unit) formed on one semiconductor chip.

### BACKGROUND ART

In recent years, integration of a micro processor has been progressed, and there has been developed a micro processor on which a plurality of central processing units are mounted such that, a single central processing unit is mounted on a micro processor, a plurality of the micro processors are mounted on a system, and the system is integrated. In the micro processor on which the plurality of central processing units are mounted, mainly due to a limitation of the number of terminals with respect to an area size of an LSI, a memory and an input/output device utilized by each central processing unit are generally shared in the micro processor, and the sharing is mainly achieved by designs of a bus (intra-processor bus) and a controller in the micro processor. More particularly, when the memory is shared, unpermitted accesses are caused due to, for example, bugs of a control software or others, and accesses in a memory region are collided to cause such a problem that image data is not correctly processed, and therefore, it is important to avoid the access collision in the memory region. Patent Document 1 discloses a technique of providing a circuit for detecting and blocking accesses to unpermitted addresses having small overhead in circuit volume.

Meanwhile, when a program is operated on the micro processor on which the plurality of central processing units are mounted, a plurality of operating systems (OS) which are basic systems are required, and a system of executing data communications among these OSs and executing a function on another OS without recognizing a plurality of CPUs and OSs is required. In such a situation, as a system of controlling the executions of the OSs and applications on the multi-processor system as described above, for example, there is a conventional technique of achieving a parallel process by operating a single-processor OS and an existing application on the multi processor as disclosed in Patent Document 2. In this manner, a mechanism of free connection between a system configuration resource such as a physical CPU and an OS or application is referred to as virtualization, and has been widely used in a field of a server or others.
Patent Document 1: Japanese Patent Application Laid-Open Publication No. 2004-334410
Patent Document 2: Japanese Patent Application Laid-Open Publication No. 2003-345614

### DISCLOSURE OF THE INVENTION

### Problems to be Solved by the Invention

In a multi-core system in which many CPUs and IPs are integrated on a single chip, complex functions are mutually related to be simultaneously operated, and therefore, a situation arises that one physical device is shared by a plurality of cores and OSs operated on these cores. In this sharing, each of main OSs in the sharing is not time-sharingly operated with the others to make only one OS active for a period of time but always active to be parallely operated to use an I/O device. In such a case, since a control register group for controlling an actual device is only one, it is required to arbitrate accesses to these registers by any means and to process accesses of a plurality of OSs by virtually recognizing one set of the control register group as a plural one. As described above, in the multi-core environment, a plurality of CPUs are simultaneously operated, and they are generally under a control of a different OS from each other. On the other hand, the number of an I/O device and a device such as an accelerator IP is limited, and therefore, it is required to share the devices by the plurality of CPUs and OSs. In such a sharing situation, there is a case that, for example, in an automotive navigation system on which a hard disc device is equipped, one hard disc device is used for storing map data and music data, and these data are simultaneously accessed by different processors from each other for route search and music reproduction.

More particularly, when a plurality of OSs are mounted, the hardware resources managed by one OS are fabricated based on an assumption that the hardware resources are not accessed by others than the one OS. An unexpected event such as accesses, more particularly data rewritings of others than the OS to a partial region of an on-chip memory or a partial region of an external memory assigned for the OS becomes a factor causing abnormal operations of the OS and a software module executed on the OS. Therefore, it is desirable to independently manage the on-chip memory and the external memory so as not to be shared by the plurality of OSs. However, the on-chip memory and the external memory cannot be unlimitedly mounted in a point of view of cost and others. Therefore, it is desirable to efficiently use the memory resources so as not to affect the other OSs. Also, even if the OSs are different from each other, they are mounted on one system, and therefore, communications among the OSs (inter-OS communications) are required. In this case, data communications are required so as not to affect the other OSs.

### Means for Solving the Problems

In the present invention for the problems described above, an information processor includes: a first central processing unit; a second central processing unit; a first operating system executed by the first central processing unit; a second operating system executed by the second central processing unit; and a memory accessed by the first central processing unit and the second central processing unit, and the information processor further includes: a firmware for assigning the first central processing unit, the first operating system, and a first region being a partial region of the memory as a first domain, assigning the second central processing unit, the second operating system, and a second region being a partial region of the memory as a second domain, and controlling not to enable an access of one domain to a region assigned for the other domain; and a middleware for controlling a communication when the data communication is required between the first domain and the second domain.

More desirably, the information processor further includes an access control module for blocking an access when one domain accesses the region assigned for the other domain based on a setting by the firmware.

Also, when a code of the first operating system and a code of the second operating system can be shared, the memory stores the sharable code in a third region being a partial region of the memory, and the firmware controls to enable read accesses of the first domain and the second domain and to disable write accesses of the same to the third region.

Further, the memory includes a fourth region for storing a communication data when the data communication is executed between the first domain and the second domain. When the firmware does not receive a request for the communication from the first domain and second domain, the firmware controls to disable the accesses of the first domain and the second domain to the fourth region. When the middleware receives a request for the execution of the data communication from the first domain to the second domain, the middleware controls the firmware to enable the access of the first domain to the fourth region and to disable the access of the second domain to the fourth region, and with this state, the access of the first domain to the fourth region is enabled.

Further, the memory includes: a fifth region to which the communication data is written when the data communication is executed from the first domain to the second domain; and a sixth region to which the communication data is written when the data communication is executed from the second domain to the first domain. The firmware controls to enable an access of the first domain to the fifth region, to disable an access of the second domain to the fifth region, to enable an access of the second domain to the sixth region, and to disable an access of the first domain to the sixth region. When the middleware receives a request for the execution of the data communication from the first domain to the second domain, the first domain writes the communication data into the fifth region, and then, the middleware instructs the firmware to disable the accesses of the first and second domains to the fifth and sixth regions, and then, the data is transferred from the fifth region to the sixth region.

### Effects of the Invention

According to the invention disclosed in the present application, in the multi-core environment, time required for the software development can be shortened, and further, input/output processing can be efficient.

### BRIEF DESCRIPTIONS OF THE DRAWINGS

FIG. 1 is a diagram illustrating a configuration of a software system;

FIG. 2 is a diagram explaining inter-domain communications among OSs and respective memory regions;

FIG. 3 is another diagram explaining inter-domain communications among OSs and respective memory regions;

FIG. 4 is still another diagram explaining inter-domain communications among OSs and respective memory regions;

FIG. 5 is still another diagram explaining inter-domain communications among OSs and respective memory regions.

### BEST MODE FOR CARRYING OUT THE INVENTION

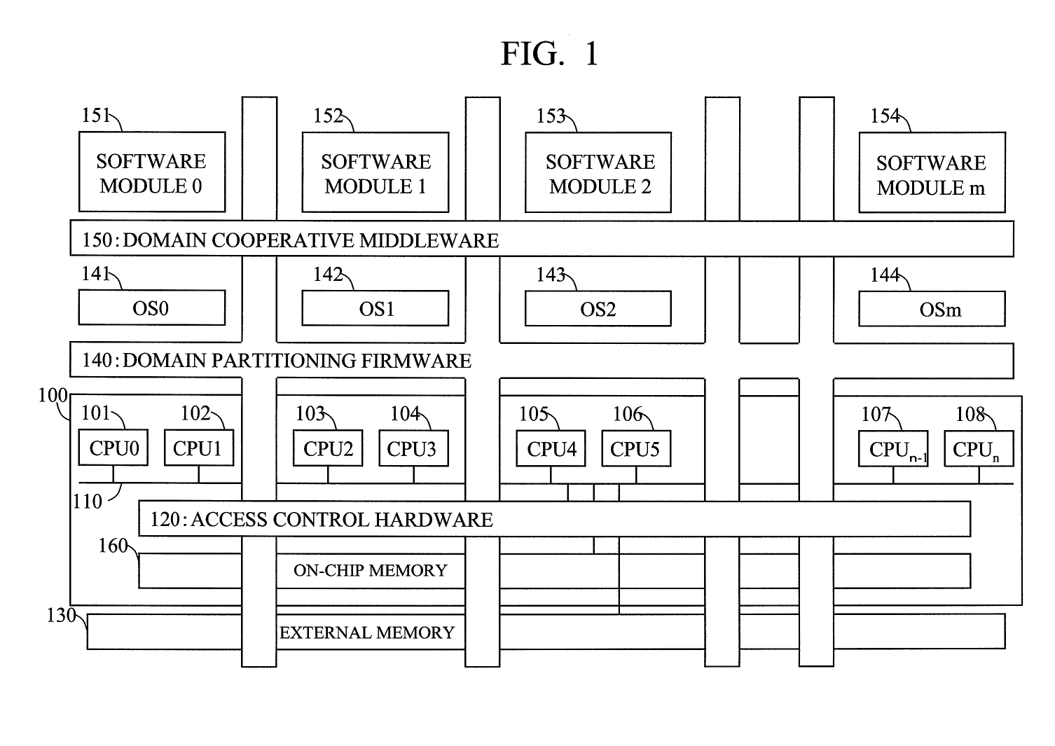

FIG. 1 illustrates one example of a configuration of a hardware and a software of an information processor according to the present invention.

A multi-core processor (100) that is a component of the hardware of the information processor according to the present embodiment has a configuration in which n pieces of a central processing unit (hereinafter, referred to as “CPU”) (CPU0 (101) to CPUn (108)), an external memory (130), an on-chip memory (160), and an access control hardware (120) are connected by an intra-processor bus (110). Each CPU can access all regions of the external memory (130) and the on-chip memory (160) via the intra-processor bus (110). Also, a memory control device for controlling the external memory and an input/output control device such as a serial IO are connected to the intra-processor bus, although not illustrated. Note that the input/output control device is included in one memory space similarly to the external memory (130) and the on-chip memory (160), and is similarly controlled, and therefore, is represented by the external memory and the on-chip memory, and descriptions for the input/output control device are omitted hereinafter.

When each of n pieces of CPUs (CPU0 (101) to CPUn (108)) accesses the external memory (130) and the on-chip memory (160) via the intra-processor bus (110), the access control hardware (120) monitors transactions generated on the intra-processor bus (110) to determine availability of the access based on a rule for determining a previously-specified access-availability for individual transactions. Here, while a transaction for a permitted access based on the rule for determining the access-availability is processed as usual, a transaction for an unpermitted access based on the rule is disabled (blocked) as an access violation, and further, an interruption signal is transmitted to the CPU having generated the transaction in order to start an exception processing for the generation of the access violation. Also, in the access control hardware (120), the availability of access of each CPU to the regions of the on-chip memory and the external memory is specified by an initial address of the memory and a region size of the same. Further, the availability of access is specified for each of read access/write access in each OS. Note that, in the setting for each region, only an OS to which the read access/write access is permitted is specified, and an access of an unset OS is not permitted. In this manner, the access control hardware (120) can be made small.

In a software configuration in the information processor according to the present embodiment, a domain partitioning firmware (140) manages the hardware resources in order to provide environments required for executing m pieces of OSs (OS0 (141), OS1 (142), and OS2 (143) to OSm (144)) on the multi-core processor (100).

More specifically, in the present embodiment, the domain partitioning firmware (140) and each of the OS0 to m (141 to 144) perform as follows, for the management of the hardware resources.

(1) The domain partitioning firmware (140) assigns two CPUs of a CPU0 (101) and a CPU1 (102), a partial region of the on-chip memory (160), and a partial region of the external memory (130) for the OS0 (141) as the hardware resources, and further, the OS0 (141) manages the assigned hardware resources, and provides an environment for executing a program for a software module 0 (151),

(2) The domain partitioning firmware (140) assigns two CPUs of a CPU2 (103) and a CPU3 (104), a partial region of the on-chip memory (160), and a partial region of the external memory (130) for the OS1 (142) as the hardware resources, and further, the OS1 (142) manages the assigned hardware resources, and provides an environment for executing a program for a software module 1 (152),

(3) The domain partitioning firmware (140) assigns two CPUs of a CPU4 (105) and a CPU5 (106), a partial region of the on-chip memory (160), and a partial region of the external memory (130) for the OS2 (143) as the hardware resources, and further, the OS2 (143) manages the assigned hardware resources, and provides an environment for executing a program for a software module 2 (153), and

(4) Hereinafter, similarly, the domain partitioning firmware (140) assigns two CPUs of a CPUn-1 (107) and a CPUn (108), a partial region of the on-chip memory (160), and a partial region of the external memory (130) for the OSm (144) as the hardware resources, and further, the OSm (144) manages the assigned hardware resources, and provides an environment for executing a program for a software module m (154).

Also, the domain partitioning firmware (140) sets the rule for determining the availability of access executed by the access control hardware (120).

Here, an ordinary OS is fabricated based on an assumption that the hardware resources managed by the OS are not accessed by others than the OS. And, an unexpected event such as accesses, more particular data rewritings of others than the OS to the partial region of the on-chip memory (160) or the partial region of the external memory (130) assigned for the OS becomes a factor causing abnormal operations of the OS and a software module executed on the OS.

In the present embodiment, in order to prevent this factor, the domain partitioning firmware (140) sets the rule for determining the availability of access for the access control hardware (120) as follows.

(1) In order to disable accesses and data rewritings of the OS1 (142) and the software module 1 (152) to the partial region of the on-chip memory (160) or the partial region of the external memory (130) assigned for the OS0 (141), accesses, more particularly data rewritings of the CPU2 (103) and the CPU3 (104) are disabled to the partial region of the on-chip memory (160) and the partial region of the external memory (130). Also, in order to disable accesses and data rewritings of the OS2 (143) and the software module 2 (153), accesses, more particularly data rewritings of the CPU4 (105) and the CPU5 (106) are disabled to the partial region of the on-chip memory (160) and the partial region of the external memory (130). Hereinafter, similarly, in order to disable accesses and data rewritings of the OSm (144) and the software module m (154), accesses, more particularly data-rewritings of the CPUn-1 (107) and the CPUn (108) are disabled to the partial region of the on-chip memory (160) and the partial region of the external memory (130),

(2) In order to disable accesses and data rewritings of the OS0 (141) and the software module 0 (151) to the partial region of the on-chip memory (160) or the partial region of the external memory (130) assigned for the OS1 (142), accesses, more particularly data rewritings of the CPU0 (101) and the CPU1 (102) are disabled to the partial region of the on-chip memory (160) and the partial region of the external memory (130). Also, in order to disable accesses and data rewritings of the OS2 (143) and the software module 2 (153), accesses, more particularly data rewritings of the CPU4 (105) and the CPU5 (106) are disabled to the partial region of the on-chip memory (160) and the partial region of the external memory (130). Hereinafter, similarly, in order to disable accesses and data rewritings of the OSm (144) and the software module m (154), accesses, more particularly data rewritings of the CPUn-1 (107) and the CPUn (108) are disabled to the partial region of the on-chip memory (160) and the partial region of the external memory (130),

(3) In order to disable accesses and data rewritings of the OS0 (141) and the software module 0 (151) to the partial region of the on-chip memory (160) or the partial region of the external memory (130) assigned for the OS2 (143), accesses, more particularly data rewritings of the CPU0 (101) and the CPU1 (102) are disabled to the partial region of the on-chip memory (160) and the partial region of the external memory (130). Also, in order to disable accesses and data rewritings of the OS1 (142) and the software module 1 (152), accesses, more particularly data rewritings of the CPU2 (103) and the CPU3 (104) are disabled to the partial region of the on-chip memory (160) and the partial region of the external memory (130). Hereinafter, similarly, in order to disable accesses and data rewritings of the OSm (144) and the software module m (154), accesses, more particularly data rewritings of the CPUn-1 (107) and the CPUn (108) are disabled to the partial region of the on-chip memory (160) and the partial region of the external memory (130), and

(4) Hereinafter, similarly, in order to disable accesses and data rewritings of the OS0 (141) and the software module 0 (151) to the partial region of the on-chip memory (160) or the partial region of the external memory (130) assigned for the OSm (144), accesses, more particularly data rewritings of the CPU0 (101) and the CPU1 (102) are disabled to the partial region of the on-chip memory (160) and the partial region of the external memory (130). Also, in order to disable accesses and data rewritings of the OS1 (142) and the software module 1 (152), accesses, more particularly data rewritings of the CPU2 (103) and the CPU3 (104) are disabled to the partial region of the on-chip memory (160) and the partial region of the external memory (130). Hereinafter, similarly, in order to disable accesses and data rewritings of the OS2 (143) and the software module 2 (153), accesses, more particularly data rewritings of the CPU4 (105) and the CPU5 (106) are disabled to the partial region of the on-chip memory (160) and the partial region of the external memory (130).

By such a setting, the resources assigned for each OS are basically not accessed by the other OSs, and therefore, the abnormal operation due to the unpermitted accesses by the other OSs can be prevented.

Further, in the present embodiment, a domain cooperative middleware (150) is mounted for the inter-OS communication. The domain cooperative middleware (150) utilizes the access control hardware (120) and the domain partitioning firmware (140) according to the present embodiment. And, in a partitioned system configuration into the hardware resources executing the OS0 (141) and the software module 0 (151), the hardware resources executing the OS1 (142) and the software module 1 (152), the software resources executing the OS2 (143) and the software module 2 (153), and similarly hereinafter, the hardware resources executing the OSm (144) and the software module m (154), the domain cooperative middleware (150) provides a communication function for cooperative processing among each of the software modules (software module 0 (151), software module 1 (152), and software module 2 (153) to software module m (154)).

In this manner, a reason for newly providing the domain cooperative middleware (150) is because of easy mounting. That is, the domain partitioning firmware basically exactly partitions among the OSs. On the other hand, the cooperation among the OSs connects each OS partitioned from each other. In this manner, when quite different functions are installed onto the domain partitioning firmware, a disconnection hole is undesirably provided among each partitioned OSs even if the inter-OS communication is not required. Meanwhile, when the function for the inter-OS communication is mounted on the OS, the function must be modified so as to recognize states of the other OSs, and therefore, the modification takes a long time. Contrarily, by the configuration of newly providing the domain cooperative middleware as the present application to issue a request for the inter-OS communication from the OS, to determine its availability by the domain cooperative middleware recognizing the entire states, and to perform the setting required for the communication to the domain partitioning firmware, the domain cooperative firmware can be mounted only when the inter-OS communication is required.

Note that the domain partitioning firmware (140) and the domain cooperative middleware (150) read an OS as needed, and the reading may be executed by a CPU in a domain to which the read OS belongs or a different CPU from the CPU.

### FIRST EMBODIMENT

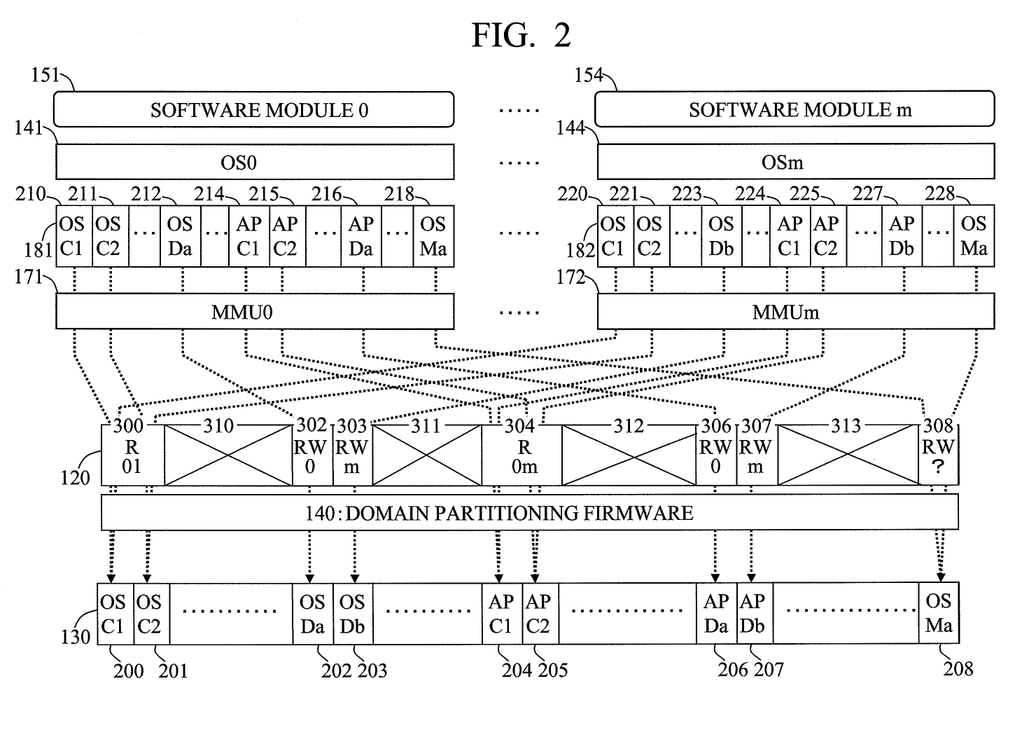

FIG. 2 illustrates to focus on the OS0 (141) and the software module 0 (151) as well as the OSm (144) and the software module m (154) in the embodiment illustrated in FIG. 1, the embodiment illustrating that there are provided only the CPUs (CPU0 (101) to CPUn (108)) and the external memory (130) as the hardware resources executing individual software modules (software module 0 (151) to software module m (154)), and the domain partitioning firmware (140) assigns the partitioned CPUs (CPU0 (101) to the CPUn (108)) and external memory (130) for each of the OSs (OS0 (141) to OSm (144)).

A virtual memory space (181) configures a memory region executed by the OS0 (141) and the software module 0 (151), a virtual memory space (182) configures a memory region executed by the OSm (144) and the software module m (154), and actual components of each virtual memory space is located on the external memory (130).

The actual components assigned on the external memory (130) as the memory region to be executed by the OS0 (141) and the software module 0 (151) include: an OS code 1 (OSC1, 200), an OS code 2 (OSC2, 201), an OS individual data a (OSDa, 202), an AP code 1 (APC1, 204), an AP code 2 (APC2, 205), an AP individual data a (APDa, 206), and an inter-OS communication data a (OSMa, 208) on the eternal memory (130), and these components are address-translated into an OS code 1 (OSC1, 210), an OS code 2 (OSC2, 211), an OS individual data a (OSDa, 212), an AP code 1 (APC1, 214), an AP code 2 (APC2, 215), an AP individual data a (APDa, 216), and an inter-OS communication data a (OSMa, 218) on the virtual memory space (181) by an MMU0 (171) to be accessed by the OS0 (141) and the software module 0 (151).

Similarly, the actual components assigned as the memory region to be executed by the OSm (144) and the software module m (154) include: an OS code 1 (OSC1, 200), an OS code 2 (OSC2, 201), an OS individual data b (OSDb, 203), an AP code 1 (APC1, 204), an AP code 2 (APC2, 205), an AP individual data b (APDb, 207), and an inter-OS communication data a (OSMa, 208) on the eternal memory (130), and these components are address-translated into an OS code 1 (OSC1, 220), an OS code 2 (OSC2, 2121), an OS individual data b (OSDb, 223), an AP code 1 (APC1, 224), an AP code 2 (APC2, 225), an AP individual data b (APDb, 227), and an inter-OS communication data a (OSMa, 228) on the virtual memory space (182) by an MMU1 (172) to be accessed by the OSm (144) and the software module m (154).

With respect to the assignments for such softwares of hardware resources, the access control hardware (120) according to the present embodiment determines the availability of access with combinations of the CPUs and the translated addresses by the MMU0 (171) and the MMU1 (172). More specifically, the domain partitioning firmware (140) sets each rule for determining the availability of access executed by the access control hardware (120) as follows.

(1) A read access of each CPU executing the OS0 (141) and the software module 0 (151) as well as the OSm (144) and the software module m (154) is enabled to an access-availability rule entry (300) for the OS code 1 (OSC1, 200) and the OS code 2 (OSC2, 201),

(2) A read/write access of a CPU executing the OS0 (141) and the software module 0 (151) is enabled to an access-availability rule entry (302) for the OS individual data a (OSDa, 202),

(3) A read/write access of a CPU executing the OSm (144) and the software module m (154) is enabled to an access-availability rule entry (303) for the OS individual data b (OSDb, 203),

(4) A read access of each CPU executing the OS0 (141) and the software module 0 (151) as well as the OSm (144) and the software module m (154) is enabled to an access-availability rule entry (304) for the AP code 1 (APC1, 204) and the AP code 2 (205),

(5) A read/write access of a CPU executing the OS0 (141) and the software module 0 (151) is enabled to an access-availability rule entry (306) for the AP individual data a (APDa, 206),

(6) A read/write access of a CPU executing the OSm (144) and the software module m (154) is enabled to an access-availability rule entry (307) for the AP individual data b (APDb, 207), and

(7) All accesses of each CPU executing the OS0 (141) and the software module 0 (151) as well as the OSm (144) and the software module m (154) are disabled to access-availability rule entries (access-availability rule entry (310), access-availability rule entry (311), access-availability rule entry (312), and access-availability rule entry (313)) for other regions of the external memory than the above-described regions.

Further, as an initial state, the domain partitioning firmware (140) sets such that all accesses of each CPU executing the OS0 (141) and software module 0 (151) as well as the OSm (144) and the software module m (154) are disabled to the access-availability rule entry (308) for the inter-OS communication data a (OSMa, 208).

Note that the meaning of reference symbols shown in the access control module (120) is that “R” stands for a read-access permission, “W” stands for a write-access permission, “0” stands for a target of the access of the CPU managed by the OS0, and “m” stands for a target of the access of the CPU managed by the OSm. Therefore, for example, “R0m” means that read accesses of the CPUs managed by the OS0 and the OSm are enabled (write accesses are disabled).

Here, the access control hardware (120) is characteristically set such that the CPUs managed by both of the OS0 and the OSm can read-access the regions (310, 313) of the OS codes 1 and 2 and the AP codes 1 and 2. As described above, it is assumed that each OS is independently operated from each other, and is not accessed by the other OSs. Therefore, it is desirable to completely partition regions managed by the OSs from each other. However, the reason why the accesses of the other OSs cause the abnormal operation is because of the data rewriting. Here, in considering an operation of the CPU, only the read access of each CPU is sufficient to the codes for the OSs and the codes for the applications. Accordingly, in the present invention, by sharing sharable codes for the OSs and applications among a plurality of OSs and setting the access control hardware (120) to enable only the read access, the write access causing the abnormal operation is blocked, so that the memory region can be safely and efficiently used. Note that this point can be also described in other embodiments.

Subsequently, the inter-OS communication is described in detail. When either one of the OS0 (141) and the software module 0 (151) or the OSm (144) and the software module m (154) executes the data-read/write to the inter-OS communication Data a (OSMa, 208) for the inter-OS communication, a request for the read/write access to the region is issued to the domain cooperative middleware (150) prior to the data-read/write. The domain cooperative middleware (150) having received the request for the read/write to the region determines whether the inter-OS communication can be executed at the moment or not, and sets to enable the read/write-accesses of the CPU executing the OS and the software module having issued the request to the access-availability rule entry (308) for the inter-OS communication Data a (OSMa, 208) via the domain partitioning firmware (140), and at the same time, controls not to enable the read/write-accesses of both of the CPUs executing the OS0 (141) and the software module 0 (151) as well as the OSm (144) and the software module m (154). And then, an acceptance of the request for the read/write-access is returned to the OS and the software module having issued the write-request.

The OS and the software module having received the acceptance of the request for the read/write-access to the inter-OS communication Data a (OSMa, 208) execute the data-read/write to the inter-OS communication Data a (OSMa, 208), and then, issue a completion of the data-read/write to the region, to the domain cooperative middleware (150).

The domain cooperative middleware (150) having received the completion of the data-read/write to the region sets, similarly to the initial state, to disable all accesses of each CPU executing the OS0 (141) and the software module 0 (151) as well as the OSm (144) and the software module m (154) to the access-availability rule entry (308) for the inter-OS communication Data a (OSMa, 208) via the domain partitioning firmware (140).

As described above, in the present embodiment, the read/write-accesses of all OSs (CPUs) to the region (208) used for the inter-OS communication are disabled by default, and the access permission is issued as needed only to the OS (CPU) issuing the request with using the domain cooperative middle ware and the domain partitioning firmware. In this manner, it is possible to prevent the access of the other OS (CPU) to data used for the communication to read the information or destroy the information.

### SECOND EMBODIMENT

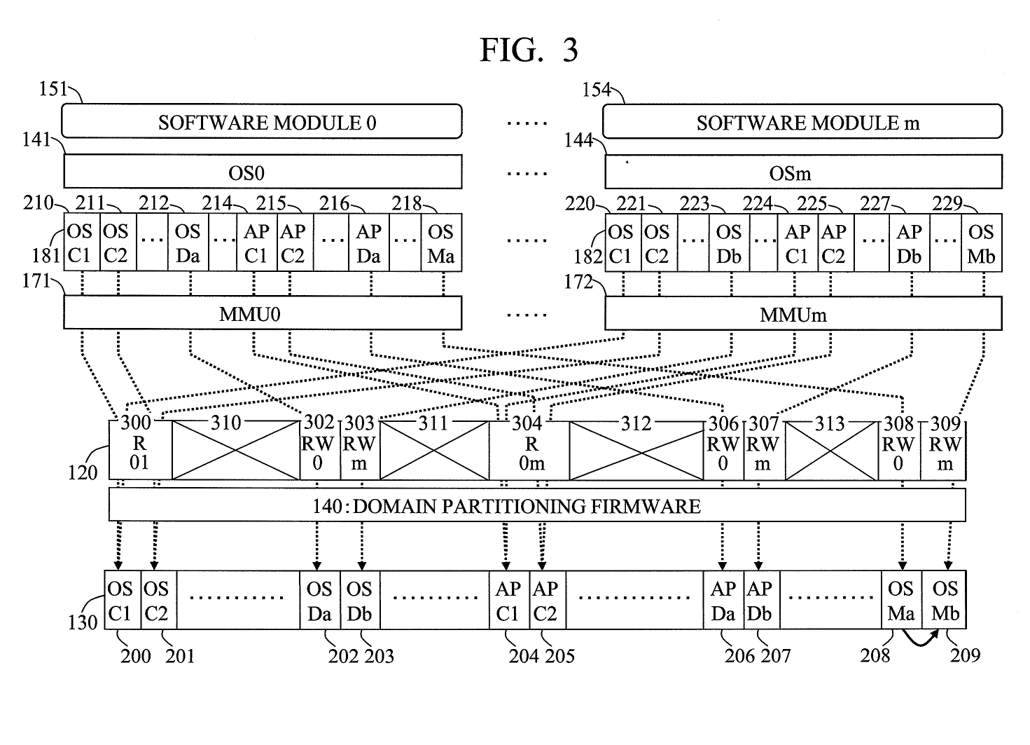

FIG. 3, similarly to FIG. 2, illustrates to focus on the OS0 (141) and the software module 0 (151) as well as the OSm (144) and the software module m (154) in the embodiment illustrated in FIG. 1, the embodiment illustrating that there are provided only the CPUs (CPU0 (101) to CPUn (108)) and the external memory (130) as the hardware resources executing individual software modules (software module 0 (151) to software module m (154)), and the domain partitioning firmware (140) assigns the partitioned CPUs (CPU0 (101) to the CPUn (108)) and the external memory (130) for each of the OSs (OS0 (141) to OSm (144)). While the memory region (208) for the inter-OS communication is shared by the OS0 and the OSm in the first embodiment, the OS0 and the OSm have respective individual regions (208, 209) in the present embodiment. Hereinafter, the present embodiment is described.

A virtual memory space (181) configures a memory region executed by the OS0 (141) and the software module 0 (151), a virtual memory space (182) configures a memory region executed by the OSm (144) and the software module m (154), and actual components of each virtual memory space is located in the external memory (130).

The actual components assigned on the external memory (130) as the memory region to be executed by the OS0 (141) and the software module 0 (151) include: an OS code 1 (OSC1, 200), an OS code 2 (OSC2, 201), an OS individual data a (OSDa, 202), an AP code 1 (APC1, 204), an AP code 2 (APC2, 205), an AP individual data a (APDa, 206), and an inter-OS communication data a (OSMa, 208) on the eternal memory (130), and these components are address-translated into an OS code 1 (OSC1, 210), an OS code 2 (OSC2, 211), an OS individual data a (OSDa, 212), an AP code 1 (APC1, 214), an AP code 2 (APC2, 215), an AP individual data a (APDa, 216), and an inter-OS communication data a (OSMa, 218) on the virtual memory space (181) by an MMU0 (171) to be accessed by the OS0 (141) and the software module 0 (151).

Similarly, the actual components assigned as the memory region to be executed by the OSm (144) and the software module m (154) include: an OS code 1 (OSC1, 200), an OS code 2 (OSC2, 201), an OS individual data b (OSDb, 203), an AP code 1 (APC1, 204), an AP code 2 (APC2, 205), an AP individual data b (APDb, 207), and an inter-OS communication data b (OSMb, 209) on the eternal memory (130), and these components are address-translated into an OS code 1 (OSC1, 220), an OS code 2 (OSC2, 221), an OS individual data b (OSDb, 223), an AP code 1 (APC1, 224), an AP code 2 (APC2, 225), an AP individual data b (APDb, 2127), and an inter-OS communication data b (OSMb, 229) on the virtual memory space (182) by an MMU1 (172) to be accessed by the OSm (144) and the software module m (154).

With respect to the assignments for such softwares of hardware resources, the access control hardware (120) according to the present embodiment determines the availability of access with combinations of the CPUs and the translated addresses by the MMU0 (171) and the MMU1 (172). Therefore, the domain partitioning firmware (140) sets each rule for determining the availability of access executed by the access control hardware (120) as follows.

(1) A read access of each CPU executing the OS0 (141) and the software module 0 (151) as well as the OSm (144) and the software module m (154) is enabled to an access-availability rule entry (300) for the OS code 1 (OSC1, 200) and the OS code 2 (OSC2, 201),

(2) A read/write access of a CPU executing the OS0 (141) and the software module 0 (151) is enabled to an access-availability rule entry (302) for the OS individual data a (OSDa, 202),

(3) A read/write access of a CPU executing the OSm (144) and the software module m (154) is enabled to an access-availability rule entry (303) for the OS individual data b (OSDb, 203),

(4) A read access of each CPU executing the OS0 (141) and the software module 0 (151) as well as the OSm (144) and the software module m (154) is enabled to an access-availability rule entry (304) for the AP code 1 (APC1, 204) and the AP code 2 (APC2, 205),

(5) A read/write access of a CPU executing the OS0 (141) and the software module 0 (151) is enabled to an access-availability rule entry (306) for the AP individual data a (APDa, 206),

(6) A read/write access of a CPU executing the OSm (144) and the software module m (154) is enabled to an access-availability rule entry (307) for the AP individual data b (APDb, 207),

(7) All accesses of each CPU executing the OS0 (141) and the software module 0 (151) as well as the OSm (144) and the software module m (154) are disabled to access-availability rule entries (access-availability rule entry (310), access-availability rule entry (311), access-availability rule entry (312), and access-availability rule entry (313)) for other regions of the external memory than the above-described regions,

(8) A read/write access of a CPU executing the OS0 (141) and the software module 0 (151) is enabled to an access-availability rule entry (308) for the inter-OS communication data a (OSMa, 208), and

(9) A read/write access of a CPU executing the OSm (144) and the software module m (154) is enabled to an access-availability rule entry (309) for the inter-OS communication data b (OSMb, 209).

In the present embodiment, when the inter-OS communication is executed from the software module 0 (151) to the software module m (154), a transfer request is issued to the domain cooperative middleware (150) at a moment of data-writing completion of the software module 0 (151) to the inter-OS communication Data a (OSMa, 208) on the external memory (130).

With using the domain partitioning firmware (140), the domain cooperative middleware (150) having received the transfer request sets to disable all accesses of each CPU executing the OS0 (141) and the software module 0 (151) as well as the OSm (144) and the software module m (154) to the access-availability rule entry (308) for the inter-OS communication Data a (OSMa, 208) and the access-availability rule entry (309) for the inter-OS communication Data b (OSMb, 209). And then, with using the domain partitioning firmware (140), the domain cooperative middleware (150) sets to enable read/write accesses of a CPU executing the domain cooperative middleware (150) itself to the access-availability rule entry (308) for the inter-OS communication Data a (OSMa, 208) and the access-availability rule entry (309) for the inter-OS communication Data b (OSMb, 209), so that a data written in the inter-OS communication Data a (OSMa, 208) is written to a specified location of the inter-OS communication Data b (OSMb, 209). And then, with using the domain partitioning firmware (140) again, the domain cooperative middleware (150) sets to disable all accesses of the CPU executing the domain cooperative middleware (150) to the access-availability rule entry (308) for the inter-OS communication Data a (OSMa, 208) and the access-availability rule entry (309) for the inter-OS communication Data b (OSMb, 209), and after this completion, with using the domain partitioning firmware (140), the domain cooperative middleware (150) sets to enable the read/write accesses of the CPU executing the OS0 (141) and the software module 0 (151) to the access-availability rule entry (308) for the inter-OS communication Data a (OSMa, 208) and enable the read/write accesses of the CPU executing the OS0m (144) and the software module m (154) to the access-availability rule entry (309) for the inter-OS communication Data b (OSMb, 209), and a transfer completion is issued to the software module 0 (151).

When the inter-OS communication is executed from the software module m (154) to the software module 0 (151), a transfer request is issued to the domain cooperative middleware (150) at a moment of the data-writing completion of the software module m (154) to the inter-OS communication Data b (OSMb, 209) on the external memory (130).

With using the domain partitioning firmware (140), the domain cooperative middleware (150) having received the transfer request sets to disable all accesses of each CPU executing the OS0 (141) and the software module 0 (151) as well as the OSm (144) and the software module m (154) to the access-availability rule entry (308) for the inter-OS communication Data a (OSMa, 208) and the access-availability rule entry (309) for the inter-OS communication Data b (OSMb, 209). And then, with using the domain partitioning firmware (140), the domain cooperative middleware (150) sets to enable read/write accesses of a CPU executing the domain cooperative middleware (150) itself to the access-availability rule entry (308) for the inter-OS communication Data a (OSMa, 208) and the access-availability rule entry (309) for the inter-OS communication Data b (OSMb, 209), so that a data written in the inter-OS communication Data b (OSMb, 209) is written to a specified location of the inter-OS communication Data a (OSMa, 208). And then, with using the domain partitioning firmware (140) again, the domain cooperative middleware (150) sets to disable all accesses of the CPU executing the domain cooperative middleware (150) to the access-availability rule entry (308) for the inter-OS communication Data a (OSMa, 208) and the access-availability rule entry (309) for the inter-OS communication Data b (OSMb, 209), and after this completion, with using the domain partitioning firmware (140), the domain cooperative middleware (150) sets to enable the read/write access of the CPU executing the OS0 (141) and the software module 0 (151) to the access-availability rule entry (308) for the inter-OS communication Data a (OSMa, 208) and enable the read/write access of the CPU executing the OS0m (144) and the software module m (154) to the access-availability rule entry (309) for the inter-OS communication Data b (OSMb, 209), and a transfer completion is issued to the software module m (154).

As described above, also in the present embodiment, the accesses of all OSs (CPUs) are disabled during the transfer of the inter-OS communication, and therefore, the communication data is not destroyed. Also, compared to the first embodiment, in each OS, the communication data can be written in its own region prior to receiving the communication permission, and therefore, the next processing can be executed, so that high-speed operation is possible.

### THIRD EMBODIMENT

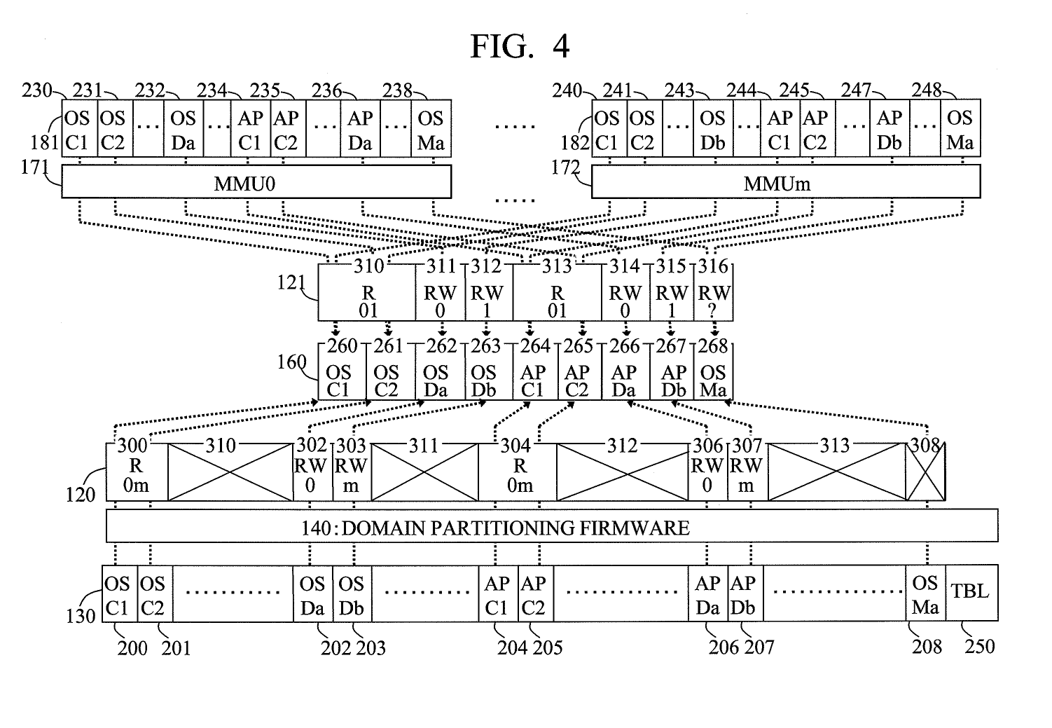

FIG. 4 illustrates to focus on the OS0 (141) and the software module 0 (151) as well as the OSm (144) and the software module m (154) in the embodiment illustrated in FIG. 1, the embodiment illustrating that there are provided the CPUs (CPU0 (101) to CPUn (108)), the external memory (130), and the on-chip memory (160) as the hardware resources executing individual software modules (software module 0 (151) to software module m (154)), and the domain partitioning firmware (140) assigns the CPUs (CPU0 (101) to the CPUn (108)), the partitioned external memory (130), and the partitioned on-chip memory (160) for each of the OSs (OS0 (141) to OSm (144)). That is, compared to the first embodiment, the present embodiment is different in that the data required for the on-chip memory (160) is copied from the external memory (130), and the CPU accesses the on-chip memory (160), so that the throughput speed is improved, and besides, the inter-OS communication is executed with using the on-chip memory. Note that, although descriptions of the OSs and the software modules are omitted due to limitations of space, these descriptions are the same as those of FIG. 2 or 3.

The actual components assigned on the external memory (130) as the memory region to be executed by the OS0 (141) and the software module 0 (151) include an OS code 1 (OSC1, 200), an OS code 2 (OSC2, 201), an OS individual data a (OSDa, 202), an AP code 1 (APC1, 204), an AP code 2 (APC2, 205), an AP individual data a (APDa, 206), and an inter-OS communication data a (OSMa, 208) on the eternal memory (130), and these actual components are copied into an OS code 1 (OSC1, 260), an OS code 2 (OSC2, 261), an OS individual data a (OSDa, 262), an AP code 1 (APC1, 264), an AP code 2 (APC2, 265), an AP individual data a (APDa, 266), and an inter-OS communication data a (OSMa, 268) on the on-chip memory (160), then, these components are address-translated into an OS code 1 (OSC1, 230), an OS code 2 (OSC2, 231), an OS individual data a (OSDa, 232), an AP code 1 (APC1, 234), an AP code 2 (APC2, 235), an AP individual data a (APDa, 236), and an inter-OS communication data a (OSMa, 238) on the virtual memory space (181) by an MMU0 (171) to be accessed by the OS0 (141) and the software module 0 (151).

Similarly, the actual components assigned as the memory region to be executed by the OSm (144) and the software module m (154) include an OS code 1 (OSC1, 200), an OS code 2 (OSC2, 201), an OS individual data b (OSDb, 203), an AP code 1 (APC1, 204), an AP code 2 (APC2, 205), an AP individual data b (APDb, 207), and an inter-OS communication data a (OSMa, 208) on the eternal memory (130), and these actual components are copied into an OS code 1 (OSC1, 260), an OS code 2 (OSC2, 261), an OS individual data b (OSDb, 263), an AP code 1 (APC1, 264), an AP code 2 (APC2, 265), an AP individual data b (APDb, 267), and an inter-OS communication data a (OSMa, 268) on the on-chip memory (160), then, these components are address-translated into an OS code 1 (OSC1, 240), an OS code 2 (OSC2, 241), an OS individual data b (OSDb, 243), an AP code 1 (APC1, 244), an AP code 2 (APC2, 245), an AP individual data b (APDb, 247), and an inter-OS communication data a (OSMa, 248) on the virtual memory space (182) by an MMU1 (172) to be accessed by the OSm (144) and the software module m (154).

An on-chip memory management table (250) manages to copy the actual components (OS code 1 (OSC1, 200), OS code 2 (OSC2, 201), OS individual data a (OSDa, 202), OS individual data b (OSDb, 203), AP code 1 (APC1, 204), AP code 2 (APC2, 205), AP individual data a (APDa, 206), AP individual data b (APDb, 207), inter-OS communication data a (OSMa, 208), and others) of an empty region on the on-chip memory (160) and the memory region on the external memory (130) to any location where (OS code 1 (OSC1, 260), OS code 2 (OSC2, 261), OS individual data a (OSDa, 262), OS individual data b (OSDb, 263), AP code 1 (APC1, 264), AP code 2 (APC2, 265), AP individual data a (APDa, 266), AP individual data b (APDb, 267), inter-OS communication data a (OSMa, 268), and others) on the on-chip memory (160).

Here, a size of the on-chip memory (160) is normally smaller than that of the external memory, and therefore, it is impossible to store all copies of the actual components assigned as the memory regions on the external memory (130) in the on-chip memory (160). Therefore, regions are secured on the on-chip memory (160) in accordance with the accesses of the software modules and the OSs, and the copies of the actual components of the memory regions on the external memory (130) to be targeted by the accesses are assigned for the regions. Here, if the on-chip memory management table (TBL, 250) confirms that the on-chip memory (160) has no space, one of the copy group of the actual components of the memory regions already assigned on the on-chip memory (160) is selected, and the copies of the actual components of the memory regions are saved in their corresponding regions on the external memory (130) to secure the region.

With respect to the assignments for such softwares of hardware resources, the access control hardware (120) according to the present embodiment determines the availability of access with combinations of the CPUs and the translated addresses by the MMU0 (171) and the MMU1 (172). Therefore, the domain partitioning firmware (140) sets each rule for determining the availability of access executed by the access control hardware (120) as follows.

(1) A read access of each CPU executing the OS0 (141) and the software module 0 (151) as well as the OSm (144) and the software module m (154) is enabled to an access-availability rule entry (300) for the OS code 1 (OSC1, 200) and the OS code 2 (OSC2, 201),

(2) A read/write access of a CPU executing the OS0 (141) and the software module 0 (151) is enabled to an access-availability rule entry (302) for the OS individual data a (OSDa, 202),

(3) A read/write access of a CPU executing the OSm (144) and the software module m (154) is enabled to an access-availability rule entry (303) for the OS individual data b (OSDb, 203),

(4) A read access of each CPU executing the OS0 (141) and the software module 0 (151) as well as the OSm (144) and the software module m (154) is enabled to an access-availability rule entry (304) for the AP code 1 (APC1, 204) and the AP code 2 (APC2, 205),

(5) A read/write access of a CPU executing the OS0 (141) and the software module 0 (151) is enabled to an access-availability rule entry (306) for the AP individual data a (APDa, 206),

(6) A read/write access of a CPU executing the OSm (144) and the software module m (154) is enabled to an access-availability rule entry (307) for the AP individual data b (APDb, 207), and

(7) All accesses of each CPU executing the OS0 (141) and the software module 0 (151) as well as the OSm (144) and the software module m (154) are disabled to access-availability rule entries for other regions of the external memory than the above-described regions.

Further, the domain partitioning firmware (140) sets each rule for determining the availability of access executed by the access control hardware (121) targeting the on-chip memory (160) as follows.

(1) A read access of each CPU executing the OS0 (141) and the software module 0 (151) as well as the OSm (144) and the software module m (154) is enabled to an access-availability rule entry (310) for the OS code 1 (OSC1, 260) and the OS code 2 (OSC2, 261),

(2) A read/write access of a CPU executing the OS0 (141) and the software module 0 (151) is enabled to an access-availability rule entry (311) for the OS individual data a (OSDa, 262),

(3) A read/write access of a CPU executing the OSm (144) and the software module m (154) is enabled to an access-availability rule entry (312) for the OS individual data b (OSDb, 263),

(4) A read access of each CPU executing the OS0 (141) and the software module 0 (151) as well as the OSm (144) and the software module m (154) is enabled to an access-availability rule entry (313) for the AP code 1 (APC1, 264) and the AP code 2 (APC2, 265),

(5) A read/write access of a CPU executing the OS0 (141) and the software module 0 (151) is enabled to an access-availability rule entry (314) for the AP individual data a (APDa, 266), and

(6) A read/write access of a CPU executing the OSm (144) and the software module m (154) is enabled to an access-availability rule entry (315) for the AP individual data b (APDb, 267).

Note that all regions of the on-chip memory are used in the present embodiment, and therefore, an unused region of the on-chip memory is not illustrated in the figures. If there is the unused region of the on-chip memory, the domain partitioning firmware (140) sets to disable all accesses of each CPU executing the OS0 (141) and the software module 0 (151) as well as the OSm (144) and the software module m (154) to an access-availability rule entry for other regions of the on-chip memory than the unused region.

Here, as an initial state, the domain partitioning firmware (140) sets such that all accesses of each CPU executing the OS0 (141) and software module 0 (151) as well as the OSm (144) and the software module m (154) are disabled to the access-availability rule entry (316) for the inter-OS communication data a (OSMa, 268).

When either one of the OS0 (141) and the software module 0 (151) or the OSm (144) and the software module m (154) executes the data-read/write to the inter-OS communication Data a (OSMa, 268) for the inter-OS communication, a request for the read/write access to the region is issued to the domain cooperative middleware (150) prior to the data-read/write.

With using the domain partitioning firmware (140), the domain cooperative middleware (150) having received the request for the read/write to the region sets to enable the read/write-accesses of the CPU executing the OS and the software module having issued the request to the access-availability rule entry (316) for the inter-OS communication Data a (OSMa, 268), and at the same time, controls not to enable the read/write-accesses of both of the CPUs executing the OS0 (141) and the software module 0 (151) as well as the OSm (144) and the software module m (154). And then, an acceptance of the request for the read/write-accesses is returned to the OS and the software module having issued the write-request.

The OS and the software module having received the acceptance of the request for the read/write-access to the inter-OS communication Data a (OSMa, 268) execute the data-read/write to the inter-OS communication Data a (OSMa, 268), and then, issue a completion of the data-read/write to the region, to the domain cooperative middleware (150).

With using the domain partitioning firmware (140), the domain cooperative middleware (150) having received the completion of the data-read/write to the region sets, similarly to the initial state, to disable all accesses of each CPU executing the OS0 (141) and the software module 0 (151) as well as the OSm (144) and the software module m (154) to the access-availability rule entry (316) for the inter-OS communication Data a (OSMa, 268).

As described above, in the present embodiment, the data required for the on-chip memory (160) is copied, and the CPU accesses the on-chip memory (160), the throughput speed can be improved. In this case, by providing the management of the access control hardware and the domain partitioning firmware in both of the on-chip memory and the external memory, each CPU can directly access not only the on-chip memory but also the external memory, so that a processing without intermediating the on-chip memory is possible. Also, for executing a safe inter-OS communication, it is required to change an OS (CPU) to which the access permission is issued by the domain partitioning firmware. Therefore, the direct accesses of all OSs (CPUs) are blocked to the region of the external memory for the inter-OS communication, and are executed only in the region of the on-chip memory. In this manner, the management of the inter-OS communication in the domain cooperative middleware becomes simple.

### FOURTH EMBODIMENT

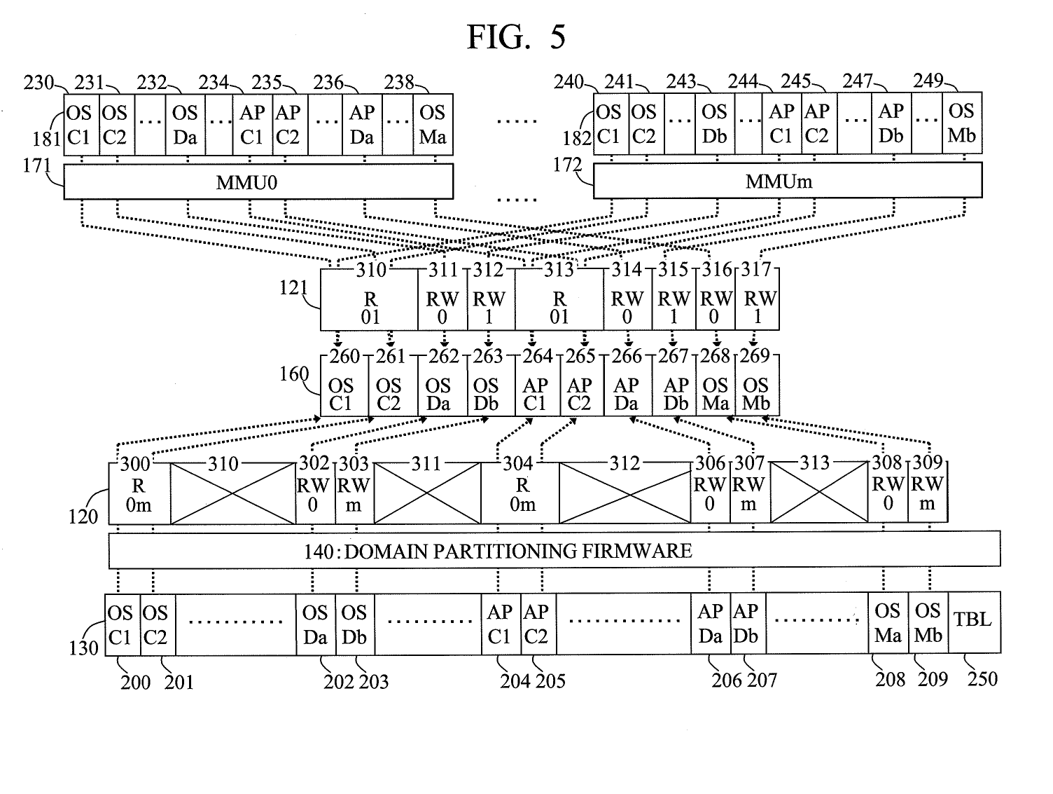

FIG. 5 illustrates to focus on the OS0 (141) and the software module 0 (151) as well as the OSm (144) and the software module m (154) in the embodiment illustrated in FIG. 1, the embodiment illustrating that there are provided the CPUs (CPU0 (101) to CPUn (108)), the external memory (130), and the on-chip memory (160) as the hardware resources executing individual software modules (software module 0 (151) to software module m (154)), and the domain partitioning firmware (140) assigns the CPUs (CPU0 (101) to the CPUn (108)), the partitioned external memory (130), and the partitioned on-chip memory (160) for each of the OSs (OS0 (141) to OSm (144)). Compared to the second embodiment, the present embodiment is different in that the data required for the on-chip memory (160) is copied from the external memory (130), and the CPU accesses the on-chip memory (160), so that the throughput speed is improved, and besides, the inter-OS communication is executed with using the on-chip memory. Note that, although descriptions of the OSs and the software modules are omitted due to limitations of space, these descriptions are the same as those of FIGS. 2 and 3.

The actual components assigned as the memory region to be executed by the OS0 (141) and the software module 0 (151) include an OS code 1 (OSC1, 200), an OS code 2 (OSC2, 201), an OS individual data a (OSDa, 202), an AP code 1 (APC1, 204), an AP code 2 (APC2, 205), an AP individual data a (APDa, 206), and an inter-OS communication data a (OSMa, 208) on the eternal memory (130), and these actual components are copied into an OS code 1 (OSC1, 260), an OS code 2 (OSC2, 261), an OS individual data a (OSDa, 262), an AP code 1 (APC1, 264), an AP code 2 (APC2, 265), an AP individual data a (APDa, 266), and an inter-OS communication data a (OSMa, 268) on the on-chip memory (160), then, these components are address-translated into an OS code 1 (OSC1, 230), an OS code 2 (OSC2, 231), an OS individual data a (OSDa, 232), an AP code 1 (APC1, 234), an AP code 2 (APC2, 235), an AP individual data a (APDa, 236), and an inter-OS communication data a (OSMa, 238) on the virtual memory space (181) by an MMU0 (171) to be accessed by the OS0 (141) and the software module 0 (151).

Similarly, the actual components assigned as the memory region to be executed by the OSm (144) and the software module m (154) include an OS code 1 (OSC1, 200), an OS code 2 (OSC2, 201), an OS individual data b (OSDb, 203), an AP code 1 (APC1, 204), an AP code 2 (APC2, 205), an AP individual data b (APDb, 207), and an inter-OS communication data b (OSMb, 209) on the eternal memory (130), and these actual components are copied into an OS code 1 (OSC1, 260), an OS code 2 (OSC2, 261), an OS individual data b (OSDb, 263), an AP code 1 (APC1, 264), an AP code 2 (APC2, 265), an AP individual data b (APDb, 267), and an inter-OS communication data b (OSMb, 269) on the on-chip memory (160), then, these components are address-translated into an OS code 1 (OSC1, 240), an OS code 2 (OSC2, 241), an OS individual data b (OSDb, 243), an AP code 1 (APC1, 244), an AP code 2 (APC2, 245), an AP individual data b (APDb, 247), and an inter-OS communication data b (OSMb, 249) on the virtual memory space (182) by an MMU1 (172) to be accessed by the OSm (144) and the software module m (154).

An on-chip memory management table (250) manages to copy the actual components (OS code 1 (OSC1, 200), OS code 2 (OSC2, 201), OS individual data a (OSDa, 202), OS individual data b (OSDb, 203), AP code 1 (APC1, 204), AP code 2 (APC2, 205), AP individual data a (APDa,206), AP individual data b (APDb, 207), inter-OS communication data a (OSMa, 208), inter-OS communication data b (OSMb, 209), and others) of an empty region on the on-chip memory (160) and the memory region on the external memory (130) to any location where (OS code 1 (OSC1, 260), OS code 2 (OSC2, 261), OS individual data a (OSDa, 262), OS individual data b (OSDb, 263), AP code 1 (APC1, 264), AP code 2 (APC2, 265), AP individual data a (APDa, 266), AP individual data b (APDb, 267), inter-OS communication data a (OSMa, 268), inter-OS communication data b (OSMb, 269), and others) on the on-chip memory (160).

Here, a size of the on-chip memory (160) is normally smaller than that of the external memory, and therefore, it is impossible to store all copies of the actual components assigned as the memory regions on the external memory (130) in the on-chip memory (160). Therefore, regions are secured on the on-chip memory (160) in accordance with the accesses of the software modules and the OSs, and the copies of the actual components of the memory regions on the external memory (130) to be targeted by the accesses are assigned for the regions on the on-chip memory (160). Here, if the on-chip memory management table (TEL, 250) confirms that the on-chip memory (160) has no space, one of the copy group of the actual components of the memory regions already assigned on the on-chip memory (160) is selected, and the copies of the actual components of the memory regions are saved in their corresponding regions on the external memory (130) to secure the region.

With respect to the assignments for such softwares of hardware resources, the access control hardware (120) according to the present embodiment determines the availability of access with combinations of the CPUs and the translated addresses by the MMU0 (171) and the MMU1 (172). Therefore, the domain partitioning firmware (140) sets each rule for determining the availability of access executed by the access control hardware (120) as follows.

(1) A read access of each CPU executing the OS0 (141) and the software module 0 (151) as well as the OSm (144) and the software module m (154) is enabled to an access-availability rule entry (300) for the OS code 1 (OSC1, 200) and the OS code 2 (OSC2, 201),

(2) A read/write access of a CPU executing the OS0 (141) and the software module 0 (151) is enabled to an access-availability rule entry (302) for the OS individual data a (OSDa, 202),

(3) A read/write access of a CPU executing the OSm (144) and the software module m (154) is enabled to an access-availability rule entry (303) for the OS individual data b (OSDb, 203),

(4) A read access of each CPU executing the OS0 (141) and the software module 0 (151) as well as the OSm (144) and the software module m (154) is enabled to an access-availability rule entry (304) for the AP code 1 (APC1, 204) and the AP code 2 (APC2, 205),

(5) A read/write access of a CPU executing the OS0 (141) and the software module 0 (151) is enabled to an access-availability rule entry (306) for the AP individual data a (APDa, 206),

(6) A read/write access of a CPU executing the OSm (144) and the software module m (154) is enabled to an access-availability rule entry (307) for the AP individual data b (APDb, 207),

(7) A read/write access of a CPU executing the OS0 (141) and the software module 0 (151) is enabled to an access-availability rule entry (308) for the inter-OS communication data a (OSMa, 208),

(8) A read/write access of a CPU executing the OSm (144) and the software module m (154) is enabled to an access-availability rule entry (309) for the inter-OS communication data b (OSMb, 209), and

(9) All accesses of each CPU executing the OS0 (141) and the software module 0 (151) as well as the OSm (144) and the software module m (154) are disabled to access-availability rule entries for other regions of the external memory than the above-described regions.

Further, the domain partitioning firmware (140) sets each rule for determining the availability of access executed by the access control hardware (121) targeting the on-chip memory (160) as follows.

(1) A read access of each CPU executing the OS0 (141) and the software module 0 (151) as well as the OSm (144) and the software module m (154) is enabled to an access-availability rule entry (310) for the OS code 1 (OSC1, 260) and the OS code 2 (OSC2, 261),

(2) A read/write access of a CPU executing the OS0 (141) and the software module 0 (151) is enabled to an access-availability rule entry (311) for the OS individual data a (OSDa, 262),

(3) A read/write access of a CPU executing the OSm (144) and the software module m (154) is enabled to an access-availability rule entry (312) for the OS individual data b (OSDb, 263),

(4) A read access of each CPU executing the OS0 (141) and the software module 0 (151) as well as the OSm (144) and the software module m (154) is enabled to an access-availability rule entry (313) for the AP code 1 (APC1, 264) and the AP code 2 (APC2, 265),

(5) A read/write access of a CPU executing the OS0 (141) and the software module 0 (151) is enabled to an access-availability rule entry (314) for the AP individual data a (APDa, 266),

(6) A read/write access of a CPU executing the OSm (144) and the software module m (154) is enabled to an access-availability rule entry (315) for the AP individual data b (APDb, 267),

(7) A read/write access of a CPU executing the OS0 (141) and the software module 0 (151) is enabled to an access-availability rule entry (316) for the inter-OS communication data a (OSMa, 268), and

(8) A read/write access of a CPU executing the OSm (144) and the software module m (154) is enabled to an access-availability rule entry (317) for the inter-OS communication data b (OSMb, 269).

Note that all regions of the on-chip memory are used in the present embodiment, and therefore, an unused region of the on-chip memory is not illustrated in the figures. If there is the unused region of the on-chip memory, the domain partitioning firmware (140) sets to disable all accesses of each CPU executing the OS0 (141) and the software module 0 (151) as well as the OSm (144) and the software module m (154) to an access-availability rule entry for other regions of the on-chip memory than the unused region.

When the inter-OS communication is executed from the software module 0 (151) to the software module m (154), a transfer request is issued to the domain cooperative middleware (150) at a moment of the data-writing completion of the software module 0 (151) to the inter-OS communication Data a (OSMa, 268) on the on-chip memory (160).

With using the domain partitioning firmware (140), the domain cooperative middleware (150) having received the transfer request sets to disable all accesses of each CPU executing the OS0 (141) and the software module 0 (151) as well as the OSm (144) and the software module m (154) to the access-availability rule entry (316) for the inter-OS communication Data a (OSMa, 268) and the access-availability rule entry (317) for the inter-OS communication Data b (OSMb, 269). And then, with using the domain partitioning firmware (140), the domain cooperative middleware (150) sets to enable read/write accesses of a CPU executing the domain cooperative middleware (150) itself to the access-availability rule entry (316) for the inter-OS communication Data a (OSMa, 268) and the access-availability rule entry (317) for the inter-OS communication Data b (OSMb, 269), so that a data written in the inter-OS communication Data a (OSMa, 268) is written to a specified location of the inter-OS communication Data b (OSMb, 269). And then, with using the domain partitioning firmware (140) again, the domain cooperative middleware (150) sets to disable all accesses of the CPU executing the domain cooperative middleware (150) to the access-availability rule entry (316) for the inter-OS communication Data a (OSMa, 268) and the access-availability rule entry (317) for the inter-OS communication Data b (OSMb, 269), and after this completion, with using the domain partitioning firmware (140), the domain cooperative middleware (150) sets to enable the read/write accesses of the CPU executing the OS0 (141) and the software module 0 (151) to the access-availability rule entry (316) for the inter-OS communication Data a (OSMa, 268) and enable the read/write accesses of the CPU executing the OS0m (144) and the software module m (154) to the access-availability rule entry (317) for the inter-OS communication Data b (OSMb, 269), and a transfer completion is issued to the software module 0 (151).

When the inter-OS communication is executed from the software module m (154) to the software module 0 (151), a transfer request is issued to the domain cooperative middleware (150) at a moment of the data-writing completion of the software module m (154) to the inter-OS communication Data b (OSMb, 269) on the external memory (130).

With using the domain partitioning firmware (140), the domain cooperative middleware (150) having received the transfer request sets to disable all accesses of each CPU executing the OS0 (141) and the software module 0 (151) as well as the OSm (144) and the software module m (154) to the access-availability rule entry (316) for the inter-OS communication Data a (OSMa, 268) and the access-availability rule entry (317) for the inter-OS communication Data b (OSMb, 269). And then, the domain cooperative middleware (150) writes a data written in the inter-OS communication Data b (OSMb, 269) to a specified location of the inter-OS communication Data a (OSMa, 268), and after this completion, with using the domain partitioning firmware (140), the domain cooperative middleware (150) sets to enable the read/write accesses of the CPU executing the OS0 (141) and the software module 0 (151) to the access-availability rule entry (316) for the inter-OS communication Data a (OSMa, 268) and enable the read/write accesses of the CPU executing the OS0m (144) and the software module m (154) to the access-availability rule entry (317) for the inter-OS communication Data b (OSMb, 269), and a transfer completion is issued to the software module m (154).

As described above, since the data processing is executed with using the on-chip memory in the present embodiment as compared with the second embodiment, high speed operation is possible.

The present invention is particularly effectively applied to a multi-processor system.

What is claimed is:

1. An information processor comprising: a first central processing unit; a second central processing unit; a first operating system executed by the first central processing unit; a second operating system executed by the second central processing unit; and a memory accessed by the first central processing unit and the second central processing unit, wherein
the information processor further includes:
a firmware for assigning the first central processing unit, the first operating system, and a first region being a partial region of the memory as a first domain, assigning the second central processing unit, the second operating system, and a second region being a partial region of the memory as a second domain, and controlling to disable an access of one domain to a region assigned for the other domain; and
a middleware for controlling a communication when the data communication is required between the first domain and the second domain.

2. The information processor according to claim 1, wherein
the information processor further includes an access control module for blocking the access of one domain to the region assigned for the other domain based on a setting by the firmware.

3. The information processor according to claim 2, wherein
the firmware sets to the access control module, such that an initial address of the first region, a size of the first region, and an assignment of the first region are paired as the first domain, and sets to the access control module, such that an initial address of the second region, a size of the second region, and an assignment of the second region are paired as the second domain.

4. The information processor according to claim 1, wherein,
when a code of the first operating system and a code of the second operating system can be shared, the memory stores the sharable code in a third region being a partial region of the memory, and the firmware controls to enable read accesses of the first domain and the second domain to the third region and to disable write accesses of the same to the third region.

5. The information processor according to claim 1, wherein
the memory includes a fourth region for storing a communication data when the data communication is executed between the first domain and the second domain,
when the firmware does not receive a request for the communication from the first domain and second domain, the firmware controls to disable accesses of the first domain and the second domain to the fourth region, and
when the middleware receives a request for the execution of the data communication from the first domain to the second domain, the middleware controls the firmware to enable the access of the first domain to the fourth region and to disable the access of the second domain to the fourth region, and with this state, the access of the first domain to the fourth region is enabled.

6. The information processor according to claim 1, wherein
the memory includes: a fifth region to which a communication data is written when the data communication is executed from the first domain to the second domain; and a sixth region to which a communication data is written when the data communication is executed from the second domain to the first domain,
the firmware controls to enable the access of the first domain to the fifth region and to disable the access of the second domain to the fifth region, and to enable the access of the second domain to the sixth region and to disable the access of the first domain to the sixth region, and
when the middleware receives a request for the execution of the data communication from the first domain to the second domain, the first domain writes the communication data into the fifth region, and then, the middleware instructs the firmware to disable the accesses of the first domain and the second domain to the fifth region and the sixth region, and then, the data is transferred from fifth region to the sixth region.

7. The information processor according to claim 1, wherein
the first domain includes a first memory management unit for address translation from a virtual memory space into a physical memory space including a region of the memory,
the second domain includes a second memory management unit for address translation from a virtual memory space into a physical memory space including a region of the memory, and
the firmware controls an access to the physical memory space.
